(19) United States
(12) Patent Application Publication
(10) Pub. No.: US 2020/0011692 A1
(43) Pub. Date: Jan. 9, 2020

(54) SYSTEMS AND METHODS FOR RECOMMENDING AN ESTIMATED TIME OF ARRIVAL

(71) Applicant: BEIJING DIDI INFINITY TECHNOLOGY AND DEVELOPMENT CO., LTD., Beijing (CN)

(72) Inventors: Shujuan SUN, Beijing (CN); Xinqi BAO, Beijing (CN); Zheng WANG, Beijing (CN)

(73) Assignee: BEIJING DIDI INFINITY TECHNOLOGY AND DEVELOPMENT CO., LTD., Beijing (CN)

(21) Appl. No.: 16/575,338

(22) Filed: Sep. 18, 2019

Related U.S. Application Data
(63) Continuation of application No. PCT/CN2017/088048, filed on Jun. 13, 2017.

(51) Int. Cl. G01C 21/34; G06N 3/08; G06N 20/20; G06N 7/00

(52) U.S. Cl. CPC G01C 21/3492; G06N 7/00; G06N 20/20; G06N 3/08

(57) ABSTRACT

The present disclosure relates to systems and methods for determining an estimated time of arrival (ETA) for a transportation service order. The systems may perform the methods to obtain at least one first feature vector associated with at least one non-quantifiable feature of a historical transportation service order; obtain at least one second feature vector associated with at least one quantified feature of the historical transportation service order; obtain a trained hybrid model by training a hybrid model including a first model and a second model, wherein the at least one first feature vector is an input of the first model and the at least one second feature vector is an input of the second model; direct the at least one storage medium to store the trained hybrid model.

### CROSS-REFERENCE TO RELATED APPLICATION

This application is a Continuation of International Application No. PCT/CN2017/088048, filed on Jun. 13, 2017, the contents of which are hereby incorporated by reference.

### TECHNICAL FIELD

The present disclosure generally relates to systems and methods for determining an estimated time of arrival (ETA) for a transportation service order, and in particular, systems and methods for determining the ETA using a hybrid model including a first model and a second model.

### BACKGROUND

With the development of Internet technology, on-demand services, such as online taxi hailing services and delivery services, play a significant role in people's daily life. For example, online taxi hailing has been heavily used by ordinary persons (e.g., a passenger). Through an online on-demand service platform, the user may request an on-demand service in the form of an on-demand service through an application installed in a user equipment, such as a smartphone terminal.

### SUMMARY

According to an aspect of the present disclosure, a system may include at least one non-transitory computer-readable storage medium and at least one processor in communication with the at least one non-transitory computer-readable storage medium. The at least one non-transitory computer-readable storage medium may include a set of instructions. When the at least one processor executing the set of instructions, the at least one processor may be directed to perform one or more of the following operations. The at least one processor may obtain first electronic signals encoding data of at least one first feature vector associated with at least one non-quantifiable feature of a historical transportation service order. The at least one processor may obtain second electronic signals encoding at least one second feature vector associated with at least one quantified feature of the historical transportation service order. The at least one processor may operate logic circuits of the at least one processor to obtain a trained hybrid model by training a hybrid model including a first model and a second model, wherein the at least one first feature vector is an input of the first model and the at least one second feature vector is an input of the second model. The at least one processor may send third electronic signals to direct the at least one storage medium to store therein a structured data of the trained hybrid model.

According to a further aspect of the present disclosure, a method may include one or more of the following operations. At least one computer server of an online on-demand service platform may obtain first electronic signals encoding data of at least one first feature vector associated with at least one non-quantifiable feature of a historical transportation service order. The least one computer server of the online on-demand service platform may obtain second electronic signals encoding at least one second feature vector associated with at least one quantified feature of the historical transportation service order. The least one computer server of the online on-demand service platform may operate logic circuits of the at least one processor to obtain a trained hybrid model by training a hybrid model including a first model and a second model, wherein the at least one first feature vector is an input of the first model and the at least one second feature vector is an input of the second model. The least one computer server of the online on-demand service platform may send third electronic signals to direct the at least one storage medium to store therein a structured data of the trained hybrid model.

According to another aspect of the present disclosure, a non-transitory machine-readable storage medium may include instructions. When the non-transitory machine-readable storage medium accessed by at least one processor of an online on-demand service platform, the instructions may cause the at least one processor to perform one or more of the following operations. The instructions may cause the at least one processor to obtain first electronic signals encoding data of at least one first feature vector associated with at least one non-quantifiable feature of a historical transportation service order. The instructions may cause the at least one processor to obtain second electronic signals encoding at least one second feature vector associated with at least one quantified feature of the historical transportation service order. The instructions may cause the at least one processor to operate logic circuits of the at least one processor to obtain a trained hybrid model by training a hybrid model including a first model and a second model, wherein the at least one first feature vector is an input of the first model and the at least one second feature vector is an input of the second model. The instructions may cause the at least one processor to send third electronic signals to direct the at least one storage medium to store therein a structured data of the trained hybrid model.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a block diagram illustrating an exemplary on-demand service system according to some embodiments of the present disclosure;

FIG. 2 is a block diagram illustrating an exemplary processing engine according to some embodiments of the present disclosure;

FIG. 3 is a schematic diagram illustrating exemplary hardware and/or software components of an exemplary mobile device on which a use terminal may be implemented according to some embodiments of the present disclosure;

FIG. 4 is a schematic diagram illustrating an exemplary physical model for predicting an ETA of a transportation service order according to some embodiments of the present disclosure;

FIG. 5 is a block diagram illustrating an exemplary processing engine according to some embodiments of the present disclosure;

FIG. 6 is a flowchart illustrating an exemplary process for determining an ETA for a transportation service order according to some embodiments of the present disclosure;

FIG. 7 is a flowchart illustrating an exemplary process for determining a hybrid model of ETA according to some embodiments of the present disclosure; and

FIG. 8 is a schematic diagram illustrating an exemplary diagram of a WDL model of ETA according to some embodiments of the present disclosure.

### DETAILED DESCRIPTION

The following description is presented to enable any person skilled in the art to make and use the present disclosure, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but is to be accorded the widest scope consistent with the claims.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprise,” “comprises,” and/or “comprising,” “include,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

These and other features, and characteristics of the present disclosure, as well as the methods of operation and functions of the related elements of structure and the combination of parts and economies of manufacture, may become more apparent upon consideration of the following description with reference to the accompanying drawings, all of which form a part of this disclosure. It is to be expressly understood, however, that the drawings are for the purpose of illustration and description only and are not intended to limit the scope of the present disclosure. It is understood that the drawings are not to scale.

The flowcharts used in the present disclosure illustrate operations that systems implement according to some embodiments in the present disclosure. It is to be expressly understood, the operations of the flowchart may be implemented not in order. Conversely, the operations may be implemented in inverted order, or simultaneously. Moreover, one or more other operations may be added to the flowcharts. One or more operations may be removed from the flowcharts.

Moreover, while the system and method in the present disclosure is described primarily in regard to distributing a request for a transportation service, it should also be understood that the present disclosure is not intended to be limiting. The system or method of the present disclosure may be applied to any other kind of on demand service. For example, the system or method of the present disclosure may be applied to transportation systems of different environments including land, ocean, aerospace, or the like, or any combination thereof. The vehicle of the transportation systems may include a taxi, a private car, a hitch, a bus, a train, a bullet train, a high speed rail, a subway, a vessel, an aircraft, a spaceship, a hot-air balloon, a driverless vehicle, or the like, or any combination thereof. The transportation system may also include any transportation system for management and/or distribution, for example, a system for sending and/or receiving an express. The application of the system or method of the present disclosure may be implemented on a user device and include a webpage, a plug-in of a browser, a client terminal, a custom system, an internal analysis system, an artificial intelligence robot, or the like, or any combination thereof.

The term “passenger,” “requestor,” “service requestor,” and “customer” in the present disclosure are used interchangeably to refer to an individual, an entity, or a tool that may request or order a service. Also, the term “driver,” “provider,” and “service provider” in the present disclosure are used interchangeably to refer to an individual, an entity, or a tool that may provide a service or facilitate the providing of the service.

The term “service request,” “request for a service,” “requests,” and “order” in the present disclosure are used interchangeably to refer to a request that may be initiated by a passenger, a service requestor, a customer, a driver, a provider, a service provider, or the like, or any combination thereof. The service request may be accepted by any one of a passenger, a service requestor, a customer, a driver, a provider, or a service provider. The service request may be chargeable or free.

The term “service provider terminal” and “driver terminal” in the present disclosure are used interchangeably to refer to a mobile terminal that is used by a service provider to provide a service or facilitate the providing of the service. The term “service requestor terminal” and “passenger terminal” in the present disclosure are used interchangeably to refer to a mobile terminal that is used by a service requestor to request or order a service.

The positioning technology used in the present disclosure may be based on a global positioning system (GPS), a global navigation satellite system (GLONASS), a compass navigation system (COMPASS), a Galileo positioning system, a quasi-zenith satellite system (QZSS), a wireless fidelity (WiFi) positioning technology, or the like, or any combination thereof. One or more of the above positioning systems may be used interchangeably in the present disclosure.

An aspect of the present disclosure relates to online systems and methods for determining an estimated time of arrival (ETA) for a transportation service order using a hybrid model of ETA. The hybrid model of ETA may incorporate two components: a first model, such as a linear regression model, and a second model, such as a deep neural network model. The linear regression model processes features such as a user's gender, address information, etc. These features are not quantified feature; and the deep neural network model processes features that is quantified, such as temperature, road width, a performance score of a driver, etc.

It should be noted that the system and method provided in the present disclosure related to training an ETA model. The training needs big data about historical traffic and driving record as well as map information of a region. One of ordinary skill in the art would have understood at the time of filing of this application that without Internet, big data is impossible to collect. Therefore, both the ETA and training an ETA model using big data is a technical solution deeply rooted in Internet technology.

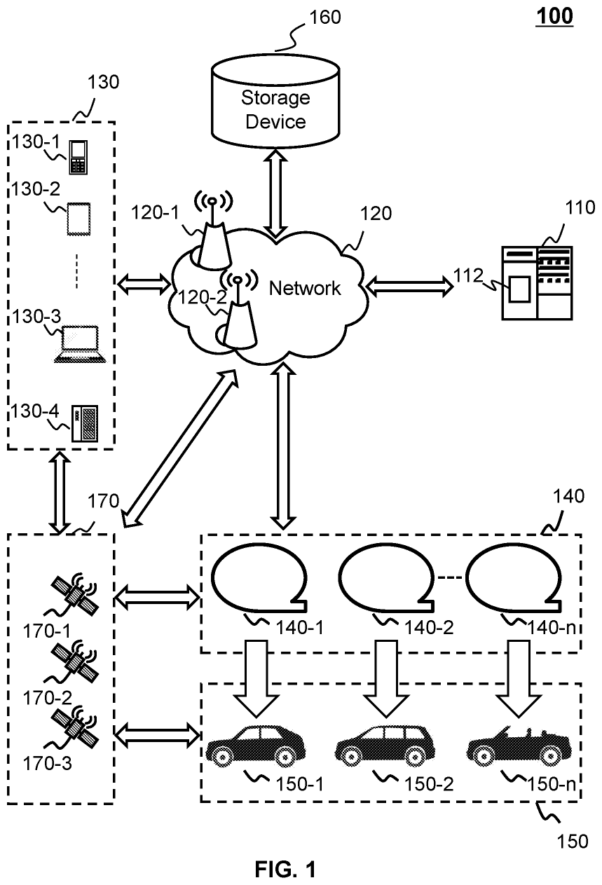

FIG. 1 is a block diagram illustrating an exemplary on-demand service system 100 according to some embodiments. For example, the on-demand service system 100 may be an online transportation service platform for transportation services. The on-demand service system 100 may include a server 110, a network 120, a service requestor terminal 130, a service provider terminal 140, a vehicle 150, a storage device 160, and a navigation system 170.

The on-demand service system 100 may provide a plurality of services. Exemplary service may include a taxi hailing service, a chauffeur service, an express car service, a carpool service, a bus service, a driver hire service, and a shuttle service. In some embodiments, the on-demand service may be any on-line service, such as booking a meal, shopping, or the like, or any combination thereof.

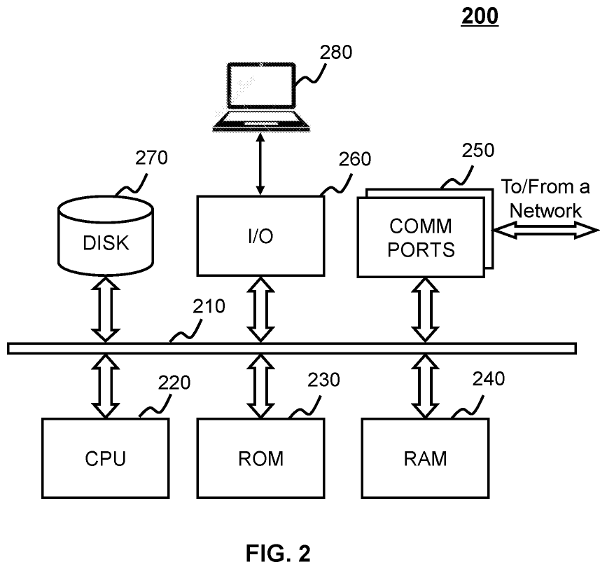

In some embodiments, the server 110 may be a single server, or a server group. The server group may be centralized, or distributed (e.g., the server 110 may be a distributed system). In some embodiments, the server 110 may be local or remote. For example, the server 110 may access information and/or data stored in the service requestor terminal 130, the service provider terminal 140, and/or the storage device 160 via the network 120. As another example, the server 110 may be directly connected to the service requestor terminal 130, the service provider terminal 140, and/or the storage device 160 to access stored information and/or data. In some embodiments, the server 110 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof. In some embodiments, the server 110 may be implemented on a computing device 200 having one or more components illustrated in FIG. 2 in the present disclosure.

In some embodiments, the server 110 may include a processing engine 112. The processing engine 112 may process information and/or data related to the service request to perform one or more functions described in the present disclosure. For example, the processing engine 112 may determine one or more candidate service provider terminals in response to the service request received from the service requestor terminal 130. In some embodiments, the processing engine 112 may include one or more processing engines (e.g., single-core processing engine(s) or multi-core processor(s)). Merely by way of example, the processing engine 112 may include a central processing unit (CPU), an application-specific integrated circuit (ASIC), an application-specific instruction-set processor (ASIP), a graphics processing unit (GPU), a physics processing unit (PPU), a digital signal processor (DSP), a field programmable gate array (FPGA), a programmable logic device (PLD), a controller, a microcontroller unit, a reduced instruction-set computer (RISC), a microprocessor, or the like, or any combination thereof.

The network 120 may facilitate exchange of information and/or data. In some embodiments, one or more components in the on-demand service system 100 (e.g., the server 110, the service requestor terminal 130, the service provider terminal 140, the vehicle 150, the storage device 160, and the navigation system 170) may send information and/or data to other component(s) in the on-demand service system 100 via the network 120. For example, the server 110 may receive a service request from the service requestor terminal 130 via the network 120. In some embodiments, the network 120 may be any type of wired or wireless network, or combination thereof. Merely by way of example, the network 120 may include a cable network, a wireline network, an optical fiber network, a tele communications network, an intranet, an Internet, a local area network (LAN), a wide area network (WAN), a wireless local area network (WLAN), a metropolitan area network (MAN), a wide area network (WAN), a public telephone switched network (PSTN), a Bluetooth network, a ZigBee network, a near field communication (NFC) network, or the like, or any combination thereof. In some embodiments, the network 120 may include one or more network access points. For example, the network 120 may include wired or wireless network access points such as base stations and/or internet exchange points 120-1, 120-2, . . . , through which one or more components of the on-demand service system 100 may be connected to the network 120 to exchange data and/or information.

In some embodiments, a passenger may be an owner of the service requestor terminal 130. In some embodiments, the owner of the service requestor terminal 130 may be someone other than the passenger. For example, an owner A of the service requestor terminal 130 may use the service requestor terminal 130 to send a service request for a passenger B, or receive a service confirmation and/or information or instructions from the server 110. In some embodiments, a service provider may be a user of the service provider terminal 140. In some embodiments, the user of the service provider terminal 140 may be someone other than the service provider. For example, a user C of the service provider terminal 140 may use the service provider terminal 140 to receive a service request for a service provider D, and/or information or instructions from the server 110. In some embodiments, “passenger” and “passenger terminal” may be used interchangeably, and “service provider” and “service provider terminal” may be used interchangeably. In some embodiments, the service provider terminal may be associated with one or more service providers (e.g., a night-shift service provider, or a day-shift service provider).

In some embodiments, the service requestor terminal 130 may include a mobile device 130-1, a tablet computer 130-2, a laptop computer 130-3, a built-in device in a vehicle 130-4, or the like, or any combination thereof. In some embodiments, the mobile device 130-1 may include a smart home device, a wearable device, a smart mobile device, a virtual reality device, an augmented reality device, or the like, or any combination thereof. In some embodiments, the smart home device may include a smart lighting device, a control device of an intelligent electrical apparatus, a smart monitoring device, a smart television, a smart video camera, an interphone, or the like, or any combination thereof. In some embodiments, the wearable device may include a smart bracelet, a smart footgear, a smart glass, a smart helmet, a smart watch, smart clothing, a smart backpack, a smart accessory, or the like, or any combination thereof. In some embodiments, the smart mobile device may include a smartphone, a personal digital assistance (PDA), a gaming device, a navigation device, a point of sale (POS) device, or the like, or any combination thereof. In some embodiments, the virtual reality device and/or the augmented reality device may include a virtual reality helmet, a virtual reality glass, a virtual reality patch, an augmented reality helmet, an augmented reality glass, an augmented reality patch, or the like, or any combination thereof. For example, the virtual reality device and/or the augmented reality device may include a Google™ Glass, an Oculus Rift, a HoloLens, a Gear VR, etc. In some embodiments, built-in device in the vehicle 130-4 may include an onboard computer, an onboard television, etc. In some embodiments, the service requestor terminal 130 may be a device with positioning technology for locating the position of the passenger and/or the service requestor terminal 130.

The service provider terminal 140 may include a plurality of service provider terminals 140-1, 140-2, . . . , 140-n. In some embodiments, the service provider terminal 140 may be similar to, or the same device as the service requestor terminal 130. In some embodiments, the service provider terminal 140 may be customized to be able to implement the online on-demand transportation service. In some embodiments, the service provider terminal 140 may be a device with positioning technology for locating the service provider, the service provider terminal 140, and/or a vehicle 150 associated with the service provider terminal 140. In some embodiments, the service requestor terminal 130 and/or the service provider terminal 140 may communicate with other positioning device to determine the position of the passenger, the service requestor terminal 130, the service provider, and/or the service provider terminal 140. In some embodiments, the service requestor terminal 130 and/or the service provider terminal 140 may periodically send the positioning information to the server 110. In some embodiments, the service provider terminal 140 may also periodically send the availability status to the server 110. The availability status may indicate whether a vehicle 150 associated with the service provider terminal 140 is available to carry a passenger. For example, the service requestor terminal 130 and/or the service provider terminal 140 may send the positioning information and the availability status to the server 110 every thirty minutes. As another example, the service requestor terminal 130 and/or the service provider terminal 140 may send the positioning information and the availability status to the server 110 each time the user logs into the mobile application associated with the online on-demand transportation service.

In some embodiments, the service provider terminal 140 may correspond to one or more vehicles 150. The vehicles 150 may carry the passenger and travel to the destination. The vehicles 150 may include a plurality of vehicles 150-1, 150-2, . . . , 150-n. One vehicle may correspond to one type of services (e.g., a taxi hailing service, a chauffeur service, an express car service, a carpool service, a bus service, a driver hire service, and a shuttle service).

The storage device 160 may store data and/or instructions. In some embodiments, the storage device 160 may store data obtained from the service requestor terminal 130 and/or the service provider terminal 140. In some embodiments, the storage device 160 may store data and/or instructions that the server 110 may execute or use to perform exemplary methods described in the present disclosure. In some embodiments, storage device 160 may include a mass storage, a removable storage, a volatile read-and-write memory, a read-only memory (ROM), or the like, or any combination thereof. Exemplary mass storage may include a magnetic disk, an optical disk, a solid-state drives, etc. Exemplary removable storage may include a flash drive, a floppy disk, an optical disk, a memory card, a zip disk, a magnetic tape, etc. Exemplary volatile read-and-write memory may include a random access memory (RAM). Exemplary RAM may include a dynamic RAM (DRAM), a double date rate synchronous dynamic RAM (DDR SDRAM), a static RAM (SRAM), a thyristor RAM (T-RAM), and a zero-capacitor RAM (Z-RAM), etc. Exemplary ROM may include a mask ROM (MROM), a programmable ROM (PROM), an erasable programmable ROM (PEROM), an electrically erasable programmable ROM (EEPROM), a compact disk ROM (CD-ROM), and a digital versatile disk ROM, etc. In some embodiments, the storage device 160 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

In some embodiments, the storage device 160 may be connected to the network 120 to communicate with one or more components in the on-demand service system 100 (e.g., the server 110, the service requestor terminal 130, the service provider terminal 140, etc.). One or more components in the on-demand service system 100 may access the data or instructions stored in the storage device 160 via the network 120. In some embodiments, the storage device 160 may be directly connected to or communicate with one or more components in the on-demand service system 100 (e.g., the server 110, the service requestor terminal 130, the service provider terminal 140, etc.). In some embodiments, the storage device 160 may be part of the server 110.

The navigation system 170 may determine information associated with an object, for example, one or more of the service requestor terminal 130, the service provider terminal 140, the vehicle 150, etc. In some embodiments, the navigation system 170 may be a global positioning system (GPS), a global navigation satellite system (GLONASS), a compass navigation system (COMPASS), a BeiDou navigation satellite system, a Galileo positioning system, a quasi-zenith satellite system (QZSS), etc. The information may include a location, an elevation, a velocity, or an acceleration of the object, or a current time. The navigation system 170 may include one or more satellites, for example, a satellite 170-1, a satellite 170-2, and a satellite 170-3. The satellites 170-1 through 170-3 may determine the information mentioned above independently or jointly. The satellite navigation system 170 may send the information mentioned above to the network 120, the service requestor terminal 130, the service provider terminal 140, or the vehicle 150 via wireless connections.

In some embodiments, one or more components in the on-demand service system 100 (e.g., the server 110, the service requestor terminal 130, the service provider terminal 140, etc.) may have permissions to access the storage device 160. In some embodiments, one or more components in the on-demand service system 100 may read and/or modify information related to the passenger, service provider, and/or the public when one or more conditions are met. For example, the server 110 may read and/or modify one or more passengers' information after a service is completed. As another example, the server 110 may read and/or modify one or more service providers' information after a service is completed.

In some embodiments, information exchanging of one or more components in the on-demand service system 100 may be initiated by way of requesting a service. The object of the service request may be any product. In some embodiments, the product may include food, medicine, commodity, chemical product, electrical appliance, clothing, car, housing, luxury, or the like, or any combination thereof. In some other embodiments, the product may include a servicing product, a financial product, a knowledge product, an internet product, or the like, or any combination thereof. The internet product may include an individual host product, a web product, a mobile internet product, a commercial host product, an embedded product, or the like, or any combination thereof. The mobile internet product may be used in a software of a mobile terminal, a program, a system, or the like, or any combination thereof. The mobile terminal may include a tablet computer, a laptop computer, a mobile phone, a personal digital assistance (PDA), a smart watch, a point of sale (POS) device, an onboard computer, an onboard television, a wearable device, or the like, or any combination thereof. For example, the product may be any software and/or application used in the computer or mobile phone. The software and/or application may relate to socializing, shopping, transporting, entertainment, learning, investment, or the like, or any combination thereof. In some embodiments, the software and/or application related to transporting may include a traveling software and/or application, a vehicle scheduling software and/or application, a mapping software and/or application, etc. In the vehicle scheduling software and/or application, the vehicle may include a horse, a carriage, a rickshaw (e.g., a wheelbarrow, a bike, a tricycle, etc.), a car (e.g., a taxi, a bus, a private car, etc.), a train, a subway, a vessel, an aircraft (e.g., an airplane, a helicopter, a space shuttle, a rocket, a hot-air balloon, etc.), or the like, or any combination thereof.

One of ordinary skill in the art would understand that when an element (or component) of the on-demand service system 100 performs, the element may perform through electrical signals and/or electromagnetic signals. For example, when a service requestor terminal 130 sends out a service request to the server 110, a processor of the service requestor terminal 130 may generate an electrical signal encoding the request. The processor of the service requestor terminal 130 may then send the electrical signal to an output port. If the service requestor terminal 130 communicates with the server 110 via a wired network, the output port may be physically connected to a cable, which further transmit the electrical signal to an input port of the server 110. If the service requestor terminal 130 communicates with the server 110 via a wireless network, the output port of the service requestor terminal 130 may be one or more antennas, which convert the electrical signal to electromagnetic signal. Similarly, a service provider terminal 130 may receive an instruction and/or service request from the server 110 via electrical signal or electromagnet signals. Within an electronic device, such as the service requestor terminal 130, the service provider terminal 140, and/or the server 110, when a processor thereof processes an instruction, sends out an instruction, and/or performs an action, the instruction and/or action is conducted via electrical signals. For example, when the processor retrieves or saves data from a storage medium, it may send out electrical signals to a read/write device of the storage medium, which may read or write structured data in the storage medium. The structured data may be transmitted to the processor in the form of electrical signals via a bus of the electronic device. Here, an electrical signal may refer to one electrical signal, a series of electrical signals, and/or a plurality of discrete electrical signals.

FIG. 2 is a schematic diagram illustrating exemplary hardware and software components of a computing device 200 on which the server 110, the service requestor terminal 130, and/or the service provider terminal 140 may be implemented according to some embodiments of the present disclosure. For example, the processing engine 112 may be implemented on the computing device 200 and configured to perform functions of the processing engine 112 disclosed in this disclosure.

The computing device 200 may be a general purpose computer or a special purpose computer, both may be used to implement an on-demand system for the present disclosure. The computing device 200 may be used to implement any component of the on-demand service as described herein. For example, the processing engine 112 may be implemented on the computing device 200, via its hardware, software program, firmware, or any combination thereof. Although only one such computer is shown, for convenience, the computer functions relating to the on-demand service as described herein may be implemented in a distributed fashion on a number of similar platforms, to distribute the processing load.

The computing device 200, for example, may include COM ports 250 connected to and from a network connected thereto to facilitate data communications. The computing device 200 may also include a central processing unit (CPU) 220, in the form of one or more processors, for executing program instructions. The exemplary computer platform may include an internal communication bus 210, program storage and data storage of different forms, for example, a disk 270, and a read only memory (ROM) 230, or a random access memory (RAM) 240, for various data files to be processed and/or transmitted by the computer. The exemplary computer platform may also include program instructions stored in the ROM 230, RAM 240, and/or other type of non-transitory storage medium to be executed by the CPU 220. The methods and/or processes of the present disclosure may be implemented as the program instructions. The computing device 200 also includes an I/O component 260, supporting input/output between the computer and other components therein such as user interface elements 280. The computing device 200 may also receive programming and data via network communications.

Merely for illustration, only one CPU and/or processor is described in the computing device 200. However, it should be note that the computing device 200 in the present disclosure may also include multiple CPUs and/or processors, thus operations steps that are performed by one CPU and/or processor as described in the present disclosure may also be jointly or separately performed by the multiple CPUs and/or processors. For example, if in the present disclosure the CPU and/or processor of the computing device 200 executes both step A and step B, it should be understood that step A and step B may also be performed by two different CPUs and/or processors jointly or separately in the computing device 200 (e.g., the first processor executes step A and the second processor executes step B, or the first and second processors jointly execute steps A and B).

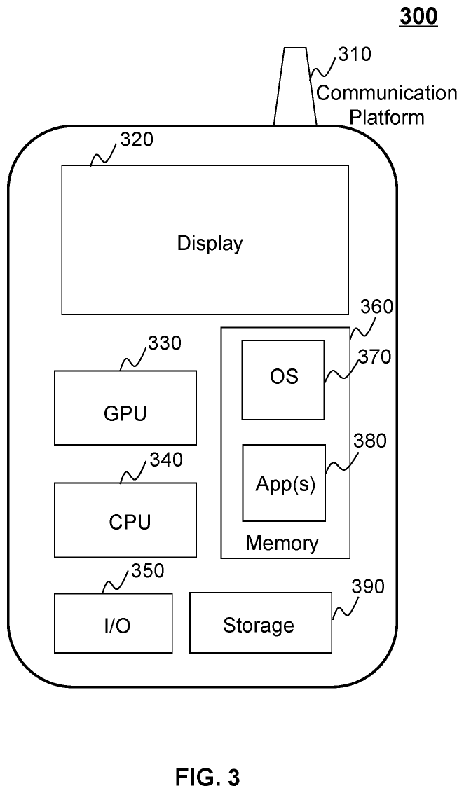

FIG. 3 is a schematic diagram illustrating exemplary hardware and/or software components of an exemplary mobile device 300 on which a use terminal may be implemented according to some embodiments of the present disclosure. As illustrated in FIG. 3, the mobile device 300 may include a communication platform 310, a display 320, a graphic processing unit (GPU) 330, a central processing unit (CPU) 340, an I/O 350, a memory 360, and a storage 390. In some embodiments, any other suitable component, including but not limited to a system bus or a controller (not shown), may also be included in the mobile device 300. In some embodiments, a mobile operating system 370 (e.g., iOS™, Android™, Windows Phone™, etc.) and one or more applications 380 may be loaded into the memory 360 from the storage 390 in order to be executed by the CPU 340. The applications 380 may include a browser or any other suitable mobile apps for receiving and rendering information relating to image processing or other information from the processing engine 112. User interactions with the information stream may be achieved via the I/O 350 and provided to the processing engine 112 and/or other components of the on-demand service system 100 via the network 120.

To implement various modules, units, and their functionalities described in the present disclosure, computer hardware platforms may be used as the hardware platform(s) for one or more of the elements described herein. A computer with user interface elements may be used to implement a personal computer (PC) or any other type of work station or terminal device. A computer may also act as a server if appropriately programmed.

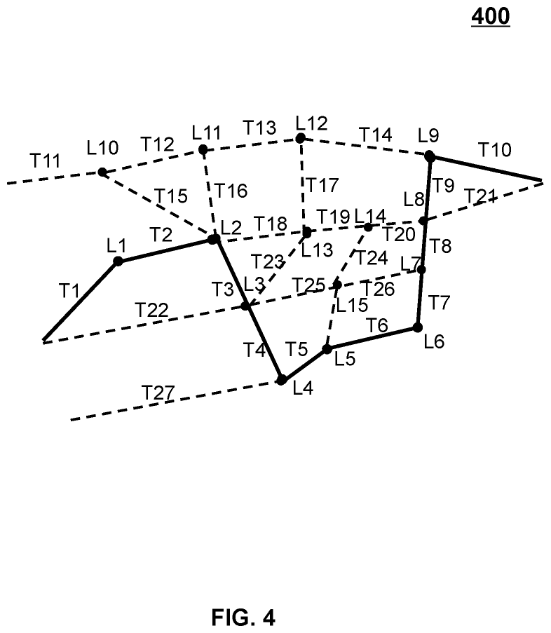

FIG. 4 is a schematic diagram illustrating an exemplary physical model for predicting an ETA of a transportation service order according to some embodiments of the present disclosure.

The processing engine 112 may determine a route 400 (shown as the bold and solid line in FIG. 4) corresponding to the transportation service order described in a road-based map. Merely by way of example, the route 400 may include 10 road sections (e.g., a first road section, a second road section, . . . , and a tenth road section) and 9 traffic lights ((e.g., a first traffic light, a second traffic light, . . . , and a ninth traffic light). Two adjacent road sections (i.e., a road link, or a link) are directly connected to each other or through one or more traffic lights (i.e., a traffic light link, or a link). For example, in FIG. 4, link T1 and link T2 are connected by traffic light L1. Time of passing through each of the road sections by a vehicle or other object may be determined based on each of speeds in road sections. The processing engine 112 may determine the ETA for the route 400 by adding the times of passing through each of the road sections and the times of passing through each of the traffic lights. Alternatively, the processing engine 112 may adopt a different model to determine the ETA for the route 400 by considering the route 400 as a whole.

In some embodiments, the processing engine 112 may determine the ETA of the route 400 according to a model of ETA. The model of ETA may be trained based on data about one or more historical service orders. For example, the processing engine 112 may extract one or more feature vectors from the data related to the historical service orders. Each of the feature vectors may be associated with one or more features or items of the historical service orders including, for example, a start location of a historical order, an end location, a start time of a historical order, an end time of a historical order, the number of traffic lights, a historical duration, or any other features described elsewhere in the present disclosure.

The processing engine 112 can then train the model of ETA based on the feature vector(s). As used herein, the term “historical service order” may refer to a service request that has been completed at any time or at a predetermined time (e.g., certain years ago, certain months ago, certain days ago, etc.). The on-demand service system 100 may save this service request as well as data during the service as a historical service order into a storage component (e.g., the storage device 160).

In some embodiments, the model of ETA may be associated with an individual link, for example, T1, T2, . . . , T10, L1, L2, . . . , L9, and adding all the times to determine an ETA. In some embodiments, the model of ETA may be trained by the feature vector in a global viewpoint (hereinafter referred to as “global feature vector”). The global feature vector may incorporate not only features of individual links, but also features describing interactions between different links. The model of ETA then may determine an ETA according to features of the overall route in the road-base map instead of merely considering features of each individual road section.

In some embodiments, the model of ETA may be a hybrid model of ETA including a first model and a second model. The hybrid model of ETA may be trained based on data associated with one or more historical transportation service orders. For example, the first model may be designed to have a first feature vector as input and the second model may be designed to have a second feature vector as input. The first feature vector may include non-quantifiable features, and the second feature vector may include quantified features. Further, the first feature vector may include non-quantifiable features only, and the second feature vector may include quantified features only. Here, a qualified feature may refer to a feature of the historical service orders that is quantifiable and quantified. For example, road width is a feature to describe road condition that can be quantitively measured, and therefore is a quantified feature (i.e., being described by a number, such as 3 meters, 10 meters, etc.). A non-quantifiable feature may refer to a feature of the historical service order that cannot be quantitively measure. For example, a particular user's ID may be a feature that either appears in a historical service order or absent from the historical service order. Therefore, there is no way to measure the user's ID with a number. Accordingly, the user's ID is a non-quantifiable feature.

The processing engine 112 may extract the first feature vector associated with a non-quantifiable feature and the second feature vector with a quantified feature of the historical service orders. The processing engine 112 may then train the hybrid model of ETA based on the first feature vector and the second feature vector. The first feature vector may be a training input of the first model and the second feature vector may be a training input of the second model.

In some embodiments, any two of the links may be related to each other. For example, an accident in 5th Avenue of Manhattan, N.Y. may block the traffic thereon. To avoid the traffic on the 5th Avenue, an increasing number of drivers may turn from the 5th Avenue to 138th Avenue of New York. As a large number of vehicles run between 5th Avenue and 138th Avenue, routes in all avenues between 5th Avenue and 138th Avenue may come into a heavy traffic status (e.g., a slow speed). Therefore, the traffic condition in the 5th Avenue may affect the traffic condition of its surrounding roads and streets.

The processing engine 112 may determine the ETA for the route 400 based on data about the road sections in the route 400 and other road sections in the road-based map. The road sections in the route 400 may be directly or indirectly related to other road sections in the road-based map. For example, a road section corresponding to T22 (shown as in FIG. 4 with dash line) may have a relationship with the road sections (e.g., the first road section) in the route 400; and a speed in the road section corresponding to T22 may affect the speed in the first road section or any other road section in the route 400. The processing engine 112 may determine the global feature vector based on the road sections in the route and other road sections in the road-based map. The model of ETA trained by the global feature vector may be used to predict the ETA for any route related to a service request in the road-based map shown as in FIG. 4.

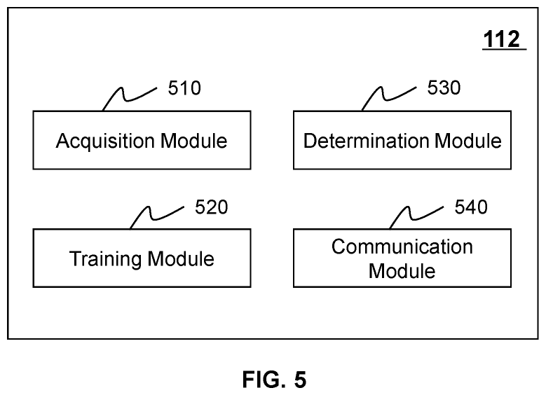

FIG. 5 is a block diagram illustrating an exemplary processing engine 112 according to some embodiments of the present disclosure. The processing engine 112 may include an acquisition module 510, a training module 520, a determination module 530, and a communication module 540. Each module may be a hardware circuit that is designed to perform the following actions, a set of instructions stored in one or more storage media, and/or any combination of the hardware circuit and the one or more storage media.

The acquisition module 510 may be configured to obtain data related to a transportation service order service. The transportation service order may be associated with a transportation service, such as a taxi hailing service, a chauffeur service, an express car service, a carpool service, a bus service, a driver hire service, and a shuttle service, a post service, a food order service. The transportation service order may refer to a service request that has been completed at any time (e.g., at present) or within a predetermined time period (e.g., several certain years ago, certain months ago, certain days ago, etc.).

The data associated with the transportation service order may include order information, transaction information, user information, map information, route information, vehicle information, weather information, traffic information, policy information, news information, or the like, or any combination thereof.

In some embodiments, the acquisition module 510 may obtained the data encoded in one or more electrical signals. In some embodiments, the acquiring module 502 may obtain the data from the service requestor terminal 130 or the storage device 160 via the network 120. Additionally or alternatively, the acquisition module 510 may obtain at least part of the data from another system (e.g., a weather condition platform, a traffic guidance platform, a traffic radio platform, a policy platform, a news platform, and/or any other system).

The training module 520 may be configured to determine and/or obtain a model for predicting ETAs (also referred to as a model of ETA). The model of ETA may be used to determine an ETA of a transportation service order. The training module 520 may generate the model of ETA based on data relating to one or more history transportation service order.

In some embodiments, the model of ETA may be a hybrid model incorporating at least two models. In some embodiments, the training module 520 may determine and/or train the hybrid model of ETA based on a machine learning method (e.g., an artificial neural networks algorithm, a deep learning algorithm, a decision tree algorithm, an association rule algorithm, an inductive logic programming algorithm). In some embodiments, the training module 520 may determine the hybrid model of ETA based on a loss of function (e.g., a difference between a predicted ETA based on the hybrid model of ETA and an actual time of arrival of the historical transportation service order).

The determination module 530 may be configured to determine one or more feature vectors associated with a transportation service order. In some embodiments, the feature vector may be expressed as a vector with one column or one row. For example, the feature vector may be a row vector expressed as a 1×N determinant (e.g., a 1×10⁸ determinant). In some embodiments, the feature vector may correspond to an N-dimensional coordinate system. The N-dimensional coordinate system may be associated with N items or features of the historical transportation service order. In some embodiments, the determination module 530 may process one or more first feature vectors at once. For example, m first features vectors (e.g., three row vectors) may be integrated into a 1×mN vector or an m×N matrix, where m is an integer.

In some embodiments, the determination module 530 may be configured to determine a first feature vector associated with non-quantifiable features and a second feature vector associated with qualified features of a transportation service order. The non-quantifiable feature may refer to a feature of the transportation service order that cannot be quantitively measure. The qualified feature may refer to a feature of the historical service orders that is quantifiable and quantified.

The communication module 540 may be configured to transmit an ETA associated with a transportation service order to at least one service requestor terminal 130 and/or the service provider terminal 140 to be displayed. In some embodiments, the ETA may be displayed on the at least one terminal via a user interface (not shown). In some embodiments, the ETA may be displayed in a format of, for example, text, images, audios, videos, etc. In some embodiments, the communication module 508 may transmit the ETA to the at least one terminal via a suitable communication protocol (e.g., the Hypertext Transfer Protocol (HTTP), Address Resolution Protocol (ARP), Dynamic Host Configuration Protocol (DHCP), File Transfer Protocol (FTP), etc.).

The modules in the processing engine 112 may be connected to or communicate with each other via a wired connection or a wireless connection. The wired connection may include a metal cable, an optical cable, a hybrid cable, or the like, or any combination thereof. The wireless connection may include a Local Area Network (LAN), a Wide Area Network (WAN), a Bluetooth, a ZigBee, a Near Field Communication (NFC), or the like, or any combination thereof. In some embodiments, any two of the modules may be combined as a single module, and any one of the modules may be divided into two or more units.

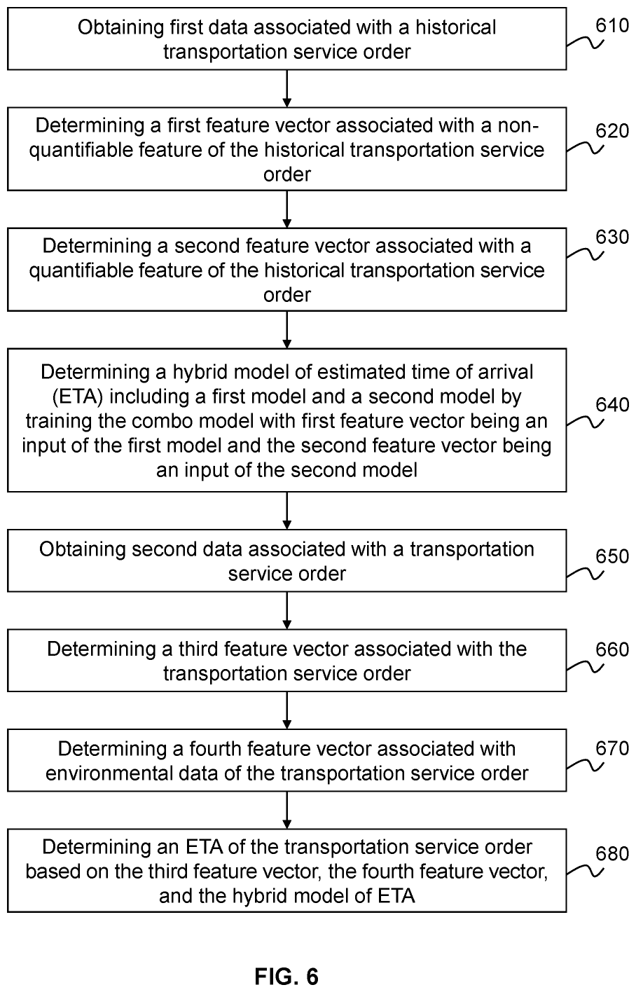

FIG. 6 is a flowchart illustrating an exemplary process 600 for determining an ETA for a transportation service order according to some embodiments of the present disclosure. The process 600 may be executed by the on-demand service system 100. For example, the process 600 may be implemented as a set of instructions (e.g., an application) stored in storage device 160. The processing engine 112 may execute the set of instructions and may accordingly be directed to perform the process 600 in an online on-demand service platform. The platform may be an Internet-based platform that connects on-demand service providers and requestors through Internet.

In 610, the processing engine 112 (e.g., the acquisition module 510) may obtain first data associated with a historical transportation service order.

The historical transportation service order may be associated with a transportation service, such as a taxi hailing service, a chauffeur service, an express car service, a carpool service, a bus service, a driver hire service, and a shuttle service, a post service, a food order service. The historical transportation service order may refer to a service request that has been completed at any time or within a predetermined time period (e.g., certain years ago, certain months ago, certain days ago, etc.).

The first data associated with the historical transportation service order may include order information, transaction information, user information, map information, route information, vehicle information, weather information, traffic information, policy information, news information, or the like, or any combination thereof. In some embodiments, the first data may be encoded by the processing engine 112 using one or more electrical signals.

The processing engine 112 may obtain the first data from a storage device (e.g., the storage device 160) in the on-demand service system 100. In some embodiments, the first data may be obtained from user terminals (e.g., the service requestor terminal 130, the service provider terminal 140). For example, the processing engine 112 may obtain the first data from a driver terminal or a passenger terminal by analyzing requests, service requests, transactions, navigation information, electronic map in user terminal, or the like, or any combination thereof.

In some embodiments, the processing engine 112 may obtain at least part of the first data from another system. The another system may include but is not limited to a weather condition platform, a traffic guidance platform, a traffic radio platform, a policy platform, a news platform, and/or any other system that may include information associated with the historical transportation service order. For example, the processing engine 112 may obtain traffic information (e.g., traffic accident information, traffic condition information, traffic restriction information) from a traffic guidance platform. As another example, the processing engine 112 may obtain weather information (e.g., real-time weather information, substantially real-time weather information, weather forecast information) from a weather forecast website.

In some embodiments, the processing engine 112 may obtain the first data according to a feature or a characteristic of the historical transportation service order. The feature of the historical transportation service order may include but is not limited to a time interval, a region, a weather, a date (e.g., a weekday, a weekend, or a holiday). For example, assuming that the historical transportation service order occurred within a predetermined time-interval of a day, the processing engine 112 may obtain the first data corresponding to the predetermined time-interval of the day. As another example, assuming that the historical transportation service order occurred within a predetermined city, the processing engine 112 may obtain the first data corresponding to the predetermined city.

In some embodiments, the processing engine 112 may obtain first data associated with a plurality of historical transportation service orders. The plurality of historical transportation service orders may be a random subset of historical transportation service orders in the on-demand service system 100. Alternatively, the plurality of historical transportation service orders may be selected from the historical transportation service orders in the on-demand service system 100 according to a feature of historical transportation service order (e.g., a date, a time interval, a region, a weather, a date). For example, the selected plurality of historical transportation service orders were all occurred in a city (e.g., New York) or a district (e.g., Long Island district of New York). As another example, the selected plurality of historical transportation service orders were all occurred during a time-interval of day (e.g., 7 a.m. to 9 a.m., a workday, a weekend, etc.). Still as another example, the selected plurality of historical transportation service orders were all occurred at days with certain weather condition (e.g., rainy days, sunny days, etc.).

In 620, the processing engine 112 (e.g., the determination module 530) may determine a first feature vector associated with non-quantifiable features of the historical transportation service orders.

In some embodiments, the first feature vector may include a plurality of non-quantifiable features of the historical transportation service orders. Further, in some embodiments, the first feature vector may include solely the plurality of non-quantifiable features.

The non-quantifiable feature may be a feature that is not described based on an amplitude (i.e., is not measured by an amplitude value) or cannot be described based on the amplitude, therefore, is not or cannot be quantified. For example, a user's gender may only be qualitatively described as male or female. It cannot be quantitively described with an amplitude value as how much percentage of a male/female and/or what degree of male/female the user is. In some embodiments, the non-quantifiable feature may be described in a form of a non-real-valued expression (e.g., a character, a string, a code, a graph, etc.). In some embodiments, the non-quantifiable feature may also be referred to as a sparse feature.

The non-quantifiable feature may include but is not limited to a non-quantifiable user feature, a non-quantifiable transaction feature, a non-quantifiable route feature, a non-quantifiable weather feature, a non-quantifiable traffic feature, a non-quantifiable news feature, a non-quantifiable vehicle feature. The non-quantifiable user feature may include a driver's ID, a driver's gender (e.g., male), a driver's preference (e.g., prefer to work at night), an evaluation of driver (e.g., patient), a passenger's name, a passenger's gender, a passenger's preference, or the like, or any combination thereof. The non-quantifiable transaction feature may include to a way of payment, or the like. The non-quantifiable route feature may include an address name of a start location (e.g., Times Square), an address name of a pickup location, an address name of a destination, a name of road along the route, a type of road (e.g., high way), and a name of city, or the like, or any combination thereof. The non-quantifiable weather feature may include a description of weather (e.g., a rainy day, a hot day), a level of air quality (e.g., good), or the like, or any combination thereof. The non-quantifiable weather feature may include a description of traffic condition (e.g., traffic jam), traffic accident information, and traffic restriction, or the like, or any combination thereof. The non-quantifiable news feature may include a description of event, such as a concert, an exhibition, a competition, a promotion, or the like, or any combination thereof. The non-quantifiable vehicle feature may include a vehicle type, a color of the vehicle, a brand of the vehicle, or the like, or any combination thereof.

In some embodiments, the first feature vector may be expressed as a vector with one column or one row. For example, the feature vector may be a row vector expressed as a 1×N determinant (e.g., a 1×10⁸ determinant). In some embodiments, the first feature vector may correspond to an N-dimensional coordinate system. The N-dimensional coordinate system may be associated with N items or features of the historical transportation service order. In some embodiments, the processing engine 112 may process one or more first feature vectors at once. For example, m first features vectors (e.g., three row vectors) may be integrated into a 1×mN vector or an m×N matrix, where m is an integer.

In some embodiments, the processing engine 112 may determine structured data of the first feature vector associated with the historical service order. The structured data of the first feature vector may be constructed or retrieved by the processing engine 112 based on a B-tree, a hash table, etc. In some embodiments, the structured data may be stored or saved in a form of a data library in the storage device 160. The first feature vector may be used to generate a plurality of training samples. The plurality of training samples may form a training set that may be used to discover potentially predictive relationships or establish a model for prediction.

In 630, the processing engine 112 (e.g., the determination module 530) may determine a second feature vector associated with quantified features of the historical transportation service orders.

In some embodiments, the second feature vector may include a plurality of quantified features of the historical transportation service orders. Further, in some embodiments, the second feature vector may include soley the plurality of quantified features.

The quantifiable feature may be a feature that can be measured by an amplitude, and thereby being described by a real-valued expression (e.g., a numerical value, a mathematical formula, a mathematical model, etc.). Accordingly, a quantified feature may be a quantifiable feature that is actually quantified with one or more values. The quantified feature may include a quantified user feature, a quantified transaction feature, a quantified route feature, a quantified weather feature, a quantified traffic feature, a quantified news feature, a quantified vehicle feature, or the like, or any combination thereof.

The quantified user feature may include a number of diver's historical transportation service orders, a performance score of a driver evaluated by passengers, a number of passenger's historical transportation service orders, a score of passenger evaluated by drivers, or the like, or any combination thereof. The quantified transaction feature may include an estimated fee, a unit price (e.g., a price per unit distance), an actual fee, or the like, or any combination thereof. The quantified feature route feature may include a coordinate of start location, a start time, an arrival time, a duration, a distance of route, a number of crossroads, a number of crossroads with traffic lights, number of crossroads without traffic lights, a number of lanes, or the like, or any combination thereof. The quantified weather feature may include an index of air quality, a temperature, a visibility, a humidity, a pressure, a wind speed, an index of PM 2.5, or the like, or any combination thereof. The quantified traffic feature may include a traffic volume, a number of traffic accidents, a speed (e.g., an average speed, an instantaneous speed), or the like, or any combination thereof. The quantified news feature may include a number of event, such as a number of concerts, a number of competitions, or the like, or any combination thereof. The quantified vehicle feature may include a number of seats in a vehicle, a trunk volume, a load capacity (e.g., a weight of products that the vehicle can carry), or the like, or any combination thereof.

In some embodiments, the second feature vector may be expressed as a vector with one column or one row as described in conjunction with operation 620. In some embodiments, the processing engine 112 may determine structured data of the second feature vector associated with the historical service order as described in connection with operation 620.

In 640, the processing engine 112 (e.g., the training module 520) may determine and/or obtain a hybrid model of estimated time of arrival (ETA) by training the hybrid model. The hybrid model may incorporate at least two models. The at least two models may be of the same mathematically theory. Alternatively, the at least two models may be of different types of models under different mathematical theories. For illustration purpose, the present disclosure takes a hybrid model that incorporates two different types of models as an example.

For example, the hybrid model may include a first model and a second model. The first model may take the first feature vector (i.e., the non-quantifiable features) as its input; and the second model may take the second feature factor (i.e., the quantified features) as its input. Further, the first model may be a linear regression model, and the second model may be a deep neural network model. The first feature vector may be a non-real-valued feature vector, and the second feature vector may be a real-valued feature vector as described with 610 and 620, respectively.

In some embodiments, the processing engine 112 may transform the first feature vector associated with a non-quantifiable feature to a binary feature vector. Additionally or alternatively, the processing engine 112 may input the binary feature vector to the first model for training. The value corresponding to a non-quantifiable feature in the feature vector may be recorded as 0 or 1 in the binary feature vector. For illustration purpose, assuming that the non-quantifiable feature is a gender of driver, the value corresponding to “male” may be 0 and the value corresponding to the “female” may be 1 in the feature vector.

In some embodiments, the first feature vector associated with the non-quantifiable feature may be transformed to a real-valued vector and then be inputted to the second model for training. The transformation of the first feature vector may be performed based on a corresponding relationship between non-quantifiable features and real values. The corresponding relationship between non-quantifiable features and real values may be record in a table, a drawing, a mathematical expression, etc. For example, a corresponding relationship between driver's occupation and real values may be recorded in a correspondence table of occupations and their corresponding real values (e.g., a look-up table) stored in a storage device (e.g., the storage device 160). The processing engine 112 may retrieve the corresponding relationship from the storage device and transform a feature vector associated with driver's occupation into a real valued feature vector based on the corresponding relationship.

In some embodiments, the processing engine 112 may determine and/or train the hybrid model of ETA based on a machine learning method. The machine learning method may include an artificial neural networks algorithm, a deep learning algorithm, a decision tree algorithm, an association rule algorithm, an inductive logic programming algorithm, a support vector machines algorithm, a clustering algorithm, a Bayesian networks algorithm, a reinforcement learning algorithm, a representation learning algorithm, a similarity and metric learning algorithm, a sparse dictionary learning algorithm, a genetic algorithms, a rule-based machine learning algorithm, or the like, or any combination thereof.

In some embodiments, the hybrid model of ETA may include a plurality of sub-hybrid models. Each of the plurality of sub-hybrid models may correspond to a predetermined scenario under which the historical service order occurred and delivered. For example, the predetermined scenario may be a predetermined date, time-interval of day, region in a map, weather, or the like, or any combination thereof. For example, a first sub-hybrid model of the hybrid model of ETA may correspond to a rainy day. As another example, a second sub-hybrid model of the hybrid model of ETA may correspond to 9:00 am to 10:00 am. Still as another example, a third sub-hybrid model of the hybrid model may correspond to a weekday in Manhattan, New York City.

A sub-hybrid model of the hybrid model of ETA may be determined based on data associated with a historical transportation service order with a corresponding feature. For example, the first sub-hybrid model corresponding to a rainy day may be determined based on data associated with a historical transportation service order occurred in a rainy day. As another example, the second sub-hybrid model corresponding to 9:00 am to 10:00 am may be determined based on data associated with a historical transportation service order whose start time and/or ending time is within the 9:00 am to 10:00 am. Still as another example, the third sub-hybrid model corresponding to a weekday in Manhattan may be determined based on data associated with a historical transportation service order occurred in a weekday day and whose start location or ending location is within Manhattan.

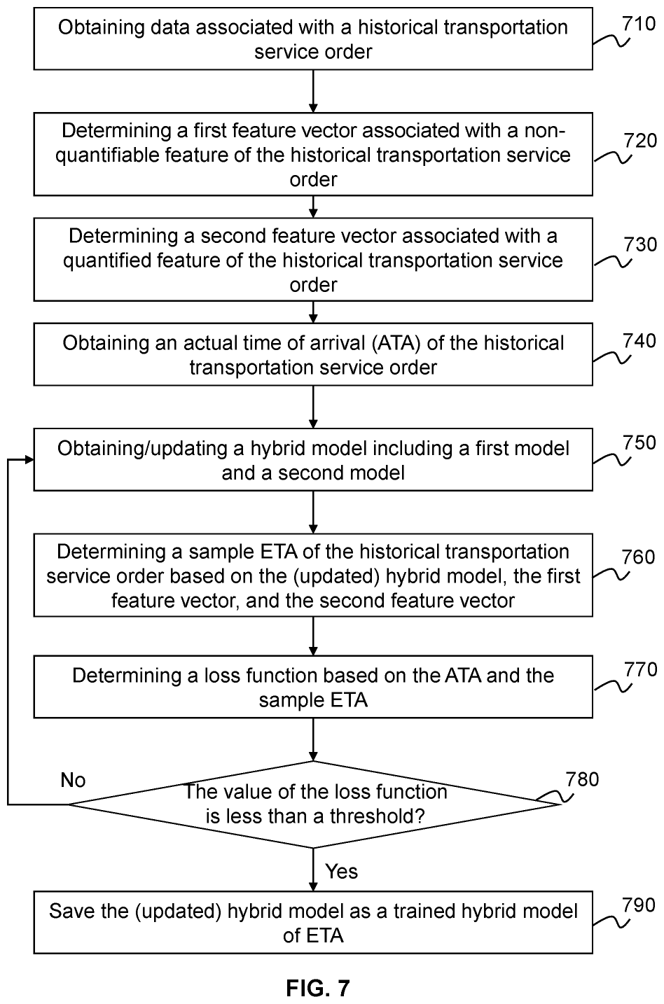

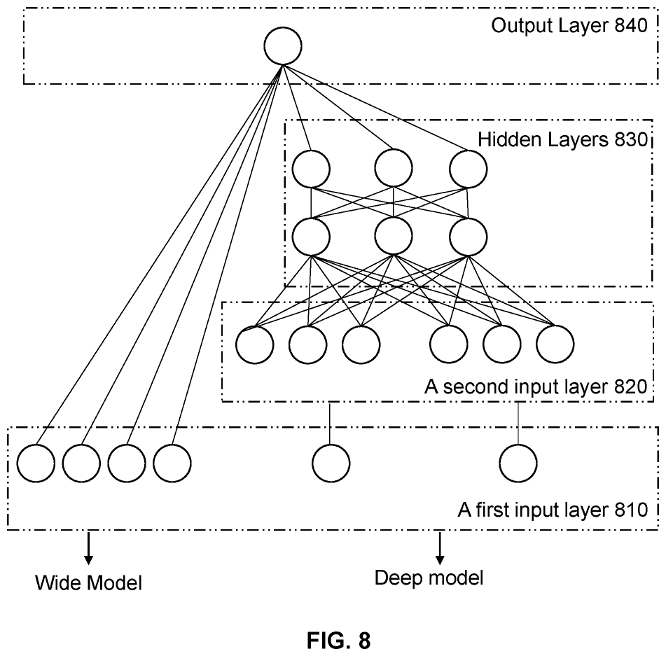

In some embodiments, the hybrid model may be a Wide and Deep Learning (WDL) model including and/or incorporating a linear regression model and a Deep Neural Network (DNN) model. The first feature vector associated with a non-quantifiable feature may be a training input of the linear regression model and the second feature vector associated with a quantified feature may be a training input of the DNN model. In some embodiments, the processing engine 112 may determine the hybrid model of ETA based on a loss of function (e.g., a difference between a predicted ETA based on the hybrid model of ETA and an actual time of arrival of the historical transportation service order). In some embodiments, the linear regression model and DNN model may be combined using a weighted sum of their output as a prediction or a weighted sum of their output log odds as the prediction. More descriptions regarding the determination of the hybrid model of ETA may be found elsewhere in the present disclosure (e.g., FIG. 7 and the relevant descriptions). More descriptions regarding the WDL model may be found elsewhere in the present disclosure (e.g., FIG. 8 and the relevant descriptions).

In 650, the processing engine 112 (e.g., the acquisition module 510) may obtain second data associated with a transportation service order.

The transportation service order may be any transportation service order as described in connection with 610 whose ETA to be determined. The transportation service order may be a real-time transportation service order, an appointed transportation service order, or a pending transportation service order. The real-time transportation service order may be a transportation service order that requires a service provider to immediately or substantially immediately process and start the service, and/or a service of which the requester wishes to receive the service at the present moment or at a defined time reasonably close to the present moment for an ordinary person in the art. The appointed transportation service order may refer to a transportation service order that does not require the service provider to immediately start the service and/or the requester wishes and/or expects to receive the service at a defined time which is reasonably long from the present moment for the ordinary person in the art. The pending transportation service order may be an on-going transportation service order that is in progress by a service provider at the present moment.

The second data associated with the transportation service order may include order information, transaction information, user information, map information, route information, vehicle information, and any other related information, or the like, or any combination thereof. The processing engine 112 may obtain the second data from a storage device (e.g., the storage device 160) in the on-demand service system 100 or another system (e.g., a weather condition platform, a traffic guidance platform, a news platform). In some embodiments, the second data may be structured data encoded by the processing engine 112 into one or more electrical signals. The second data associated with transportation service order may be substantial similar with the first data associated with the historical transportation service order as described in connection with 610, and is not repeated here.

In 660, the processing engine 112 (e.g., determination module 530) may determine a third feature vector associated with non-quantifiable features of the transportation service orders. Operation 660 may be performed in a substantially similar way with 620, and is therefore not repeated here.

In 670, the processing engine 112 (e.g., determination module 530) may determine a fourth feature vector associated with quantified features of the transportation service orders. Operation 670 may be performed in a substantially similar way with 630, and therefore is not repeated here.

In 680, the processing engine 112 (e.g., determination module 530) may determine an ETA of the transportation service order based on the third feature vector, the fourth feature vector, and the hybrid model of ETA including the first model and the second model. The processing engine 112 may determine the ETA of the transportation service order by inputting the third feature vector to the first model and the fourth feature vector to the second model. In some embodiments, operation 580 may be implemented in an electronic device such a smartphone, a personal digital assistant (PDA), a tablet computer, a laptop, a carputer (board computer), a play station portable (PSP), a pair of smart glasses, a smart watch, a wearable devices, a virtual display device, display enhanced equipment (e.g. a Google™ Glass, an Oculus Rift, a HoloLens, or a Gear VR), or the like, or any combination thereof.

It should be noted that the above descriptions of process 600 are provided for the purposes of illustration, and not intended to limit the scope of the present disclosure. For persons having ordinary skills in the art, various modifications and changes in the forms and details of the application of the above method and system may occur without departing from the principles in the present disclosure.

However, those variations and modifications also fall within the scope of the present disclosure. In some embodiments, one or more operations may be added or omitted. For example, operations of 650 to 680 may be omitted. As another example, an additional operation may be performed after 680 to send the ETA of the transportation service order to at least one terminal (e.g., a service requestor terminal 130, a service provider terminal 140.) via the network 120. In some embodiments, the order of the operations in process 600 may be changed. For example, 620 and 630 may be performed simultaneously or in any order.

In some embodiments, before 620, the processing engine 112 may determine a feature vector associated with features of the historical transportation service order. The feature vector may include a non-quantifiable feature and a quantified feature of the historical transportation service order. The processing engine 112 may then determine the first feature vector associated with the non-quantifiable feature and the second feature vector associated with the quantified feature based on the feature vector.

In some embodiments, as described in connection with 640, the hybrid model of ETA may include a plurality of sub-hybrid models. Each of the plurality of sub-hybrid models may correspond to a date, a time-interval of day, a region in a map, a weather, or the like, or any combination thereof. In 680, the processing engine 112 may select a sub-hybrid model corresponding to the transportation service order and determine the ETA of the transportation service order based on the third feature vector, the fourth feature vector, and the selected sub-hybrid model. The sub-hybrid model corresponding to the transportation service order may be selected based on a feature of the transportation service order (e.g., a date, a time-interval of day, a region in a map, a weather, etc.). For example, the processing engine 112 may determine a region of a starting location or an ending location of the transportation service order, and select a sub-hybrid model of ETA corresponding to the region in the map based on the starting location or the ending location. As another example, the processing engine 112 may determine a time interval of a starting time or ending time of the transportation service order, and a sub-hybrid model of ETA corresponding to time interval based on the starting time or the ending time.

FIG. 7 is a flowchart illustrating an exemplary process 700 for determining a hybrid model of ETA according to some embodiments of the present disclosure. The process 700 may be executed by the on-demand service system 100. For example, the process 700 may be implemented as a set of instructions (e.g., an application) stored in storage device 160. The processing engine 112 may execute the set of instructions and may accordingly be directed to perform the process 700 in an online on-demand service platform. The platform may be an Internet-based platform that connects on-demand service providers and requestors through Internet. In some embodiments, the process 700 may be an embodiment of operation 640 with reference to FIG. 6.

In 710, the processing engine 112 (e.g., the training module 520) may obtain data associated with a historical transportation service order. Operation 710 may be performed in a substantially similar way with 610 as described in connection with FIG. 6, and therefore is not repeated here.

In 720, the processing engine 112 (e.g., the training module 520) may determine a first feature vector associated with a non-quantifiable feature of the historical transportation service order. Operation 720 may be performed in a substantially similar way with 620 as described in connection with FIG. 6, and therefore is not repeated here.

In 730, the processing engine 112 (e.g., the training module 520) may determine a second feature vector associated with a quantified feature of the historical transportation service order. Operation 730 may be performed in a substantially similar way with 630 as described in connection with FIG. 6, and therefore is not repeated here.

In 740, the processing engine 112 (e.g., the training module 520) may obtain an actual time of arrival (ATA) of the historical transportation service order. The processing engine 112 may obtain the ATA of the historical transportation service order from a storage device 160 via the network 120. The ATA of the historical transportation service order may be a time point at which the service provider dropped off the passenger.

In 750, the processing engine 112 (e.g., the training module 520) may obtain a hybrid model including a first model and a second model. The hybrid model may include default settings by the on-demand service system 100 or may be adjustable in different situations. The hybrid model may be a WDL model including a linear regression model and a DNN model illustrated in FIG. 8. The WDL model may include a plurality of preliminary parameters, for example, a number of kernels, a size of each kernel, a number of processing layer, weights of the first model and the second model, etc. The preliminary parameters of the hybrid model may include default settings by the on-demand service system 100 or may be adjustable in different situations.

In 760, the processing engine 112 (e.g., the training module 520) may determine and/or select a sample ETA of the historical transportation service order based on the hybrid model, the first feature vector, and the second feature vector. The processing engine 112 may input the first feature vector to the first model and the second feature vector to the second model, and determine the sample ETA based on the plurality of preliminary parameters. In some embodiments, as described in connection with operation 640, the first feature vector may be transformed to a real-valued vector and be inputted in the second model. In some embodiments, the sample ETA may be a weight of sum of the output of the first model and the output of the second model.

In 770, the processing engine 112 (e.g., the training module 520) may determine a loss function based on the ATA and the sample ETA. The loss function may indicate an accuracy of the hybrid model. In some embodiments, the processing engine 112 may determine the loss function based on a difference between the ATA and the sample ETA. The difference between the ATA and the sample ETA may be determined based on an algorithm including, for example, a mean absolute percent error (MAPE), a mean squared error (MSE), a root mean square error (RMSE), or the like, or any combination thereof. Merely by way of example, the processing engine 112 may determine the loss of function based on the MAPE according to Equation (1) as described below:

$$M A P E = \frac{\vert ATA - {ETA}_{S} \vert}{ATA} \cdot 100 \% \qquad Equation ( 1 )$$

wherein ETAₛ refers to the sample ETA.

In 780, the processing engine 112 (e.g., the training module 520) may determine whether the value of the loss function (e.g., the difference between the ATA and the sample ETA) is less than a threshold. The threshold may be default settings by the on-demand service system 100 or may be adjustable in different situations.

In response to the determination that the value of the loss function is less than the threshold, the processing engine 112 may save the hybrid model as a trained hybrid model of ETA in 790. In some embodiments, the processing engine 112 may save the trained hybrid model of ETA a storage medium (e.g., a storage device 160) in forms as structured data. The structured data of the trained hybrid model of ETA may be constructed or retrieved by the processing engine 112 based on a B-tree or a hash table. In some embodiments, the structured data may be stored or saved as a form of a data library in the storage device

On the other hand, in response to the determination that the value of the loss function is larger than or equal to the threshold, the processing engine 112 may execute the process 700 to return to 750 to update the hybrid model until the value of the loss function is less than the threshold. For example, the processing engine 112 may update the plurality of preliminary parameters (e.g., the number of kernels, the size of each kernels, the number of the processing layers, the weights of the first model and the second model). Further, if the processing engine 112 determines that under the updated parameters, the value of the loss function is less than the threshold, the processing engine 112 may save the updated hybrid model as the trained hybrid model in 790. On the other hand, if the processing engine 112 determines that under the updated parameters, the value of the loss function is larger than or equal to the threshold, the processing engine 112 may still execute the process 700 to return to 750 to further update the parameters. The iteration from steps 750 through 780 may continue until the processing engine 112 determines that under newly updated parameters the value of the loss function is less than the threshold, and the processing engine 112 may save the updated preliminary hybrid model as the trained neural network model.

FIG. 8 is a schematic diagram illustrating an exemplary diagram of a WDL model of ETA according to some embodiments of the present disclosure. The WDL model may include a wide component (the left component illustrated in FIG. 8) and a deep component (the right component illustrated in FIG. 8).

In some embodiments, the wide component may be a linear regression model and the deep component may be a DNN model. The WDL model may include a first input layer 810 and an output layer 840. The DNN model may further include a second input layer 820 and hidden layers 830. The second input layer 820 may also be referred to as a dense embedding of the DNN model. The first input layer 810, the second input layer 820, the hidden layers 830, and the output layer 840 may include one or more artificial neurons (shown as circles in FIG. 8), respectively. In some embodiments, the first input layer 810 may be an input layer for sparse, non-real-valued feature vectors (e.g., a first feature vector associated with a non-quantifiable feature of historical transportation service order) and the second input layer 820 may be an input layer for dense, real-valued feature vectors (e.g., a second feature vector associated a quantified feature of historical transportation service order).

The linear regression model may be described according to Equation (2) below:

y=w^{T}x+b, Equation(2)

wherein x=[x₁; x₂; . . . , x_{d}] refers to a feature vector including d features, W=[w₁; w₂; . . . ; w_{d}] refers parameters associated with the liner regression model, b is a bias of the linear regression model, and y refers to an output of the linear regression model.

The feature vector inputted to the linear regression model may be a first feature vector associated with a non-quantifiable feature of a historical transportation service order as described in connection with FIG. 6. In some embodiments, the first feature vector may be transformed to a binary first feature vector and then be inputted to the linear regression model. The binary first feature vector may be determined based on a transformation Equation (3) described as below:

ϕₖ(x)=Πᵢ₌₁^{d}xᵢ^{C}^{ₖᵢ}Cₖᵢ∈{0,1} Equation(3),

wherein Cₖᵢ refers to a Boolean variable that may be equal to 1 when the i^{th} feature is within the k^{th} transformation ϕₖ, and be equal to 0 otherwise.

Merely by way of example, for a binary non-quantifiable feature such as a gender of a driver, the transformation equation (e.g., gender=female) may be equal to 1 if the gender of the driver is female, and 0 if the gender of the driver is male. Alternatively, the transformation equation (e.g., gender=female) may be equal to 0 if the gender of the driver is female, and 1 if the gender of the driver is male.

In the DNN model, each of the artificial neurons in the i^{th} layer may be connected with each of the artificial neurons in the (i−1)^{th} layer, and each of the artificial neurons in the i^{th} layer may be connected with artificial neuron in the (i+1)^{th} layer.

The feature vector inputted to the second input layer of the DNN model may include a second feature vector associated with a quantified feature of a historical transportation service order as described in connection with FIG. 6. The second feature vector may be a real-valued vector. Additionally or alternatively, the feature vector inputted to the second input layer of the DNN model may include a transformed first feature vector associated with non-quantifiable feature. The transformed first feature vector may be constructed by transforming the first feature vector to a real-valued vector based on a corresponding relationship between non-quantifiable features and real values as described in connection with operation 640 in FIG. 6.

The second feature vector or the transformed first feature vector may be initialized randomly and then inputted to the second input layer. The values of the second feature vector or the transformed first feature vector may be determined in the training to minimize the loss of function (as described in connection of FIG. 7.) of the hybrid model. The second feature vector or the transformed first feature vector may be then fed into the hidden layers of the DNN model in a forward pass. The output vector of the last hidden may be an output of the DNN model. Each hidden layer may perform Equation (4) as described below:

a^{(l+1)}=f(W^{(l)}a^{(l)}+b^{(l)}) Equation(4),

wherein l refers to a layer number, f refers to an activation function (e.g., a ReLU function), a^{(l)} refers to an output vector of the l^{th} layer, b^{(l)} refers to a bias of the DNN model of the l^{th} layer, W^{(l)} refers to a weight of the DNN model of the l^{th} layer.

The linear regression model and DNN model may be combined using a weighted sum of their output as a prediction, which is then feed to a loss of function for training. Alternatively, the linear regression model and DNN model may be combined using a weighted sum of their output log odds as a prediction, which is then feed to a loss of function for training.

In the training, the parameters associated with the linear regression model, the parameters associated with the DNN model, as well as the weights of their sum may be optimized. In some embodiments, the WDL model may be trained by back-propagating the gradients from the output to both the linear regression model and the DNN model simultaneously using mini-batch stochastic optimization. For example, the WDL model may be trained based on a Follow-the-regularized-leader (FTRL) algorithm.

It should be noted that the WDL model illustrated in FIG. 8 is merely provided for illustration purposes, and not intended to limit the scope of the present disclosure. For persons having ordinary skills in the art, various modifications and changes in the forms and details of the application of the above method and system may occur without departing from the principles in the present disclosure. For example, the DNN model may any number of hidden layers. As another example, the DNN model may be modified or trained by deep learning methods.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “unit,” “module,” or “system.” Furthermore, aspects of the present disclosure may take the form of a computer program product embodied in one or more computer readable media having computer readable program code embodied thereon.

A computer readable signal medium may include a propagated data signal with computer readable program code embodied therein, for example, in baseband or as part of a carrier wave. Such a propagated signal may take any of a variety of forms, including electro-magnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB. NET, Python, or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claimed subject matter may lie in less than all features of a single foregoing disclosed embodiment.

1. A system, comprising:
at least one non-transitory computer-readable storage medium including a set of instructions;
at least one processor in communication with the at least one non-transitory computer-readable storage medium, wherein when executing the instructions, the at least one processor is directed to:
obtain at least one first feature vector associated with at least one non-quantifiable feature of a historical transportation service order;
obtain at least one second feature vector associated with at least one quantified feature of the historical transportation service order;
obtain a trained hybrid model by training a hybrid model including a first model and a second model, wherein the at least one first feature vector is an input of the first model and the at least one second feature vector is an input of the second model, the hybrid model is a Wide and Deep Learning (WDL) model of estimated time of arrival (ETA), the first model is a linear regression model, and the second model is a Deep Neural Network model; and
direct the at least one storage medium to store the trained hybrid model, wherein to obtain a trained WDL model of ETA, the at least one processor is further directed to:
obtain an actual time of arrival (ATA) of the historical transportation service order;
obtain the WDL model;
determine a sample ETA of the historical transportation service order based on the WDL model, the first feature vector, and the second feature vector;
determine a loss function based on the ATA and the sample ETA;
determine whether a value of the loss function is less than a threshold; and
save the WDL model as the trained WDL model of ETA in response to the determination that the value of the loss function is less than the threshold.

2. (canceled)

3. The system of claim 1, wherein the WDL model of ETA includes a plurality of sub-WDL models, each of the plurality of sub-WDL models corresponding to at least one of time-interval of day or region in a map.

4. (canceled)

5. The system of claim 1, wherein the loss function is a Mean Absolute Percentage Error (MAPE) function.

6. The system of claim 1, wherein the at least one non-quantifiable feature includes at least one of a user's ID, a user's gender, a user's preference, an evaluation of user, a way of payment, an address name of start location, an address name of pickup location, an address name of destination, a name of road along a route, a type of road, a name of city, a description of weather, a level of air quality, a description of traffic condition, a traffic restriction, a description of event, a vehicle type, a color of the vehicle, or a brand of the vehicle.

7. The system of claim 1, wherein the at least one quantified feature includes at least one of a number of user' historical transportation service orders, a performance score of user, an estimated fee, a unit price, an actual fee, a coordinate of start location, a start time, an arrival time, a duration, a distance of route, a number of crossroads, a number of crossroads with traffic lights, a number of crossroads without traffic lights, a number of lanes, an index of air quality, a temperature, a visibility, a humidity, a pressure, a wind speed, an index of PM 2.5, a traffic volume, a number of traffic accidents, a speed, a number of event, a number of seats in a vehicle, a trunk volume, or a load capacity.

8. A method implemented on a computing device having at least one processor, at least one non-transitory computer-readable storage medium, and a communication platform connected to a network, comprising:
obtaining at least one first feature vector associated with at least one non-quantifiable feature of a historical transportation service order;
obtaining at least one second feature vector associated with at least one quantified feature of the historical transportation service order;
obtaining a trained hybrid model by training a hybrid model including a first model and a second model, wherein the at least one first feature vector is an input of the first model and the at least one second feature vector is an input of the second model, the hybrid model is a Wide and Deep Learning (WDL) model of estimated time of arrival (ETA), the first model is a linear regression model, and the second model is a Deep Neural Network model; and
directing the at least one storage medium to store the trained hybrid model, wherein the obtaining the, wherein the obtaining a trained WDL model of ETA further comprises:
obtaining an actual time of arrival (ATA) of the historical transportation service order;
obtaining the WDL model;
determining a sample ETA of the historical transportation service order based on the WDL model, the first feature vector, and the second feature vector;
determining a loss function based on the ATA and the sample ETA;
determining whether a value of the loss function is less than a threshold; and
saving the WDL model as the trained WDL model of ETA in response to the determination that the value of the loss function is less than the threshold.

9. (canceled)

10. The method of claim 8, wherein the WDL model of ETA includes a plurality of sub-WDL models, each of the plurality of sub-WDL models corresponding to at least one of time-interval of day or region in a map.

11. (canceled)

12. The method of claim 8, wherein the loss function is a MAPE function.

13. The method of claim 8, wherein the at least one non-quantifiable feature includes at least one of a user's ID, a user's gender, a user's preference, an evaluation of user, a way of payment, an address name of start location, an address name of pickup location, an address name of destination, a name of road along a route, a type of road, a name of city, a description of weather, a level of air quality, a description of traffic condition, a traffic restriction, a description of event, a vehicle type, a color of the vehicle, or a brand of the vehicle.

14. The method of claim 8, wherein the at least one quantified feature includes at least one of a number of user' historical transportation service orders, a performance score of user, an estimated fee, a unit price, an actual fee, a coordinate of start location, a start time, an arrival time, a duration, a distance of route, a number of crossroads, a number of crossroads with traffic lights, a number of crossroads without traffic lights, a number of lanes, an index of air quality, a temperature, a visibility, a humidity, a pressure, a wind speed, an index of PM 2.5, a traffic volume, a number of traffic accidents, a speed, a number of event, a number of seats in a vehicle, a trunk volume, or a load capacity.

15. A non-transitory computer-readable storage medium including instructions that, when accessed by at least one processor, causes the at least one processor to:
obtain at least one first feature vector associated with at least one non-quantifiable feature of a historical transportation service order;
obtain at least one second feature vector associated with at least one quantified feature of the historical transportation service order;
obtain a trained hybrid model by training a hybrid model including a first model and a second model, wherein the at least one first feature vector is an input of the first model and the at least one second feature vector is an input of the second model, the hybrid model is a Wide and Deep Learning (WDL) model of estimated time of arrival (ETA), the first model is a linear regression model, and the second model is a Deep Neural Network model; and
direct the at least one storage medium to store the trained hybrid model, wherein to obtain a trained WDL model of ETA, the at least one processor is further directed to:
obtain an actual time of arrival (ATA) of the historical transportation service order;
obtain the WDL model;
determine a sample ETA of the historical transportation service order based on the WDL model, the first feature vector, and the second feature vector;
determine a loss function based on the ATA and the sample ETA;
determine whether a value of the loss function is less than a threshold; and
save the WDL model as the trained WDL model of ETA in response to the determination that the value of the loss function is less than the threshold.

16-17. (canceled)

18. The non-transitory computer-readable medium of claim 15, wherein the loss function is a MAPE function.

19. The non-transitory computer-readable medium of claim 15, wherein the at least one non-quantifiable feature includes at least one of a user's ID, a user's gender, a user's preference, an evaluation of user, a way of payment, an address name of start location, an address name of pickup location, an address name of destination, a name of road along a route, a type of road, a name of city, a description of weather, a level of air quality, a description of traffic condition, a traffic restriction, a description of event, a vehicle type, a color of the vehicle, or a brand of the vehicle.

20. The non-transitory computer-readable medium of claim 15, wherein the at least one quantified feature includes at least one of a number of user' historical transportation service orders, a performance score of user, an estimated fee, a unit price, an actual fee, a coordinate of start location, a start time, an arrival time, a duration, a distance of route, a number of crossroads, a number of crossroads with traffic lights, a number of crossroads without traffic lights, a number of lanes, an index of air quality, a temperature, a visibility, a humidity, a pressure, a wind speed, an index of PM 2.5, a traffic volume, a number of traffic accidents, a speed, a number of event, a number of seats in a vehicle, a trunk volume, or a load capacity.

21. The non-transitory computer-readable medium of claim 15, wherein the WDL model of ETA includes a plurality of sub-WDL models, each of the plurality of sub-WDL models corresponding to at least one of time-interval of day or region in a map.
